(19) United States
(12) Patent Application Publication
(10) Pub. No.: US 2022/0204077 A1
(43) Pub. Date: Jun. 30, 2022

(54) STEERING CONTROL DEVICE AND CONTROL METHOD FOR WIRE-CONTROLLED VEHICLE

(71) Applicant: INDUSTRIAL TECHNOLOGY RESEARCH INSTITUTE, Hsinchu (TW)

(72) Inventors: Yu-Chun HSIAO, Yuanlin City (TW); Yi-Lun CHENG, Taichung City (TW); Yung-Chen WANG, Kaohsiung City (TW)

(73) Assignee: INDUSTRIAL TECHNOLOGY RESEARCH INSTITUTE, Hsinchu (TW)

(21) Appl. No.: 17/136,211

(22) Filed: Dec. 29, 2020

(51) Int. Cl. B62D 6/00; B62D 15/02; B62D 5/04

(52) U.S. Cl. CPC B62D 6/008; B62D 5/0463; B62D 15/021

(57) ABSTRACT

A steering control device is provided to output a vehicle steering control signal to a wire-controlled vehicle. The wire-controlled vehicle generates a vehicle steering feedback signal corresponding to the vehicle steering control signal. The steering load drive unit is configured to feedback a steering feel to an operator. The response discrimination unit obtains a steering angle command, a steering angle feedback, and a vehicle velocity according to the vehicle steering control signal and the feedback signal, and performs a Fourier transform to obtain a steering angle gain and a steering angle phase to identify a response characteristic of the wire-controlled vehicle. The steering angle feedback, vehicle velocity, steering angle gain, and steering angle phase are inputted into a steering system model to simulate a steering load of the wire-controlled vehicle, and the steering load is inputted to the steering load drive unit to generate the steering feel.

### TECHNICAL FIELD

The disclosure relates in general to a steering control device and a method for a wire-controlled vehicle.

### BACKGROUND

In response to the development in vehicle active safety and autonomous vehicle system, the demand for a control-by-wire vehicle is ever increasing. The steer-by-wire system, an essential device to autonomous vehicle, not only responds to the operator's steering command in real-time, but further conceals the steering wheel and creates more cabin space. Due to the absence of a mechanic link between the steering wheel and the front/rear wheels, the road feel cannot be directly fed back to the operator. Therefore, a vehicle feedback device is used to provide a real road feel to the operator.

Particularly, when the operator performs a dangerous real vehicle test, normally the driving command comes from a remote wired/wireless control device. However, if the vehicle malfunctions or gradually loses control during the test and the remote control device cannot provide correct road feel feedback, it is very likely that the vehicle may be damaged. Therefore, it is very important to truthfully feedback real vehicle state and road feel when testing the vehicle.

### SUMMARY

The present disclosure relates to a steering control device and a method for a wire-controlled vehicle to provide real vehicle state and driving feel to the operator.

According to one embodiment, a steering control device for a wire-controlled vehicle is provided. The steering control device, wirelessly or wiredly connected to the wire-controlled vehicle, includes a steering control interface, a steering load drive unit and a processor. The steering control interface is configured to output a vehicle steering control signal to the wire-controlled vehicle. The wire-controlled vehicle generates a vehicle steering feedback signal corresponding to the vehicle steering control signal. The steering load drive unit is configured to feedback a steering feel to an operator. The processor includes a response discrimination unit and a steering load simulation unit, the response discrimination unit obtains a steering angle command, a steering angle feedback, and a vehicle velocity according to the vehicle steering control signal and the feedback signal, and performs a Fourier transform to obtain a steering angle gain and a steering angle phase to identify a response characteristic of the wire-controlled vehicle. The steering load simulation unit is connected to the response discrimination unit and the steering load drive unit respectively, and the steering angle feedback, the vehicle velocity, the steering angle gain, and the steering angle phase are inputted into a steering system model to simulate a steering load of the wire-controlled vehicle, and the steering load is input to the steering load drive unit to generate a steering feel.

According to another embodiment, a steering control method for a wire-controlled vehicle is provided. The steering control method includes the following steps. A vehicle steering control signal is inputted to the wire-controlled vehicle, wherein the wire-controlled vehicle generates a vehicle steering feedback signal corresponding to the vehicle steering control signal. A steering angle command, a steering angle feedback and a vehicle velocity are obtained according to the vehicle steering control signal and the vehicle steering feedback signal. A Fourier transform is performed to obtain a steering angle gain and a steering angle phase to identify a response characteristic of the wire-controlled vehicle. The steering angle feedback, the vehicle velocity, the steering angle gain, and the steering angle phase are input into a steering system model to simulate a steering load of the wire-controlled vehicle. The steering load is input to a steering load drive unit to generate a steering feel.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a steering control device and a steer-by-wire system using the same according to an embodiment of the present disclosure;

FIG. 2 is a schematic diagram of a steering control method according to an embodiment of the present disclosure;

FIG. 3 is an operation diagram of a response discrimination unit according to an embodiment of the present disclosure;

FIGS. 4A and 4B respectively are schematic diagrams of steering angle gain and the steering angle phase corresponding to the response characteristic of the wire-controlled vehicle; and

FIG. 5 is a schematic diagram of a steering system model according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Detailed descriptions of the disclosure are disclosed below with a number of embodiments. However, the disclosed embodiments are for explanatory and exemplary purposes only, not for limiting the scope of protection of the disclosure. Similar/identical designations are configured to indicate similar/identical elements.

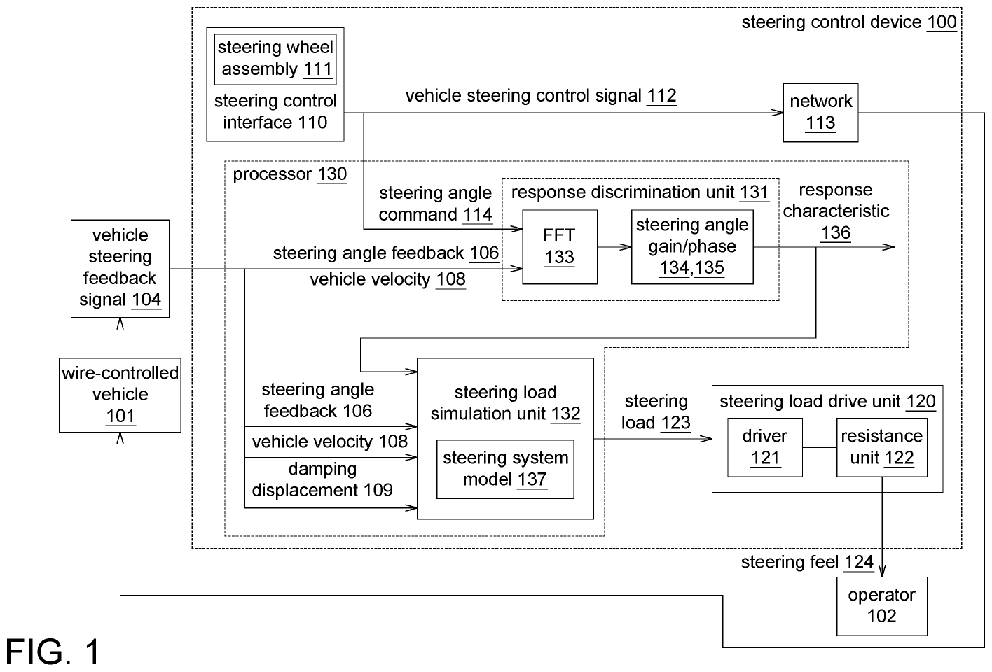

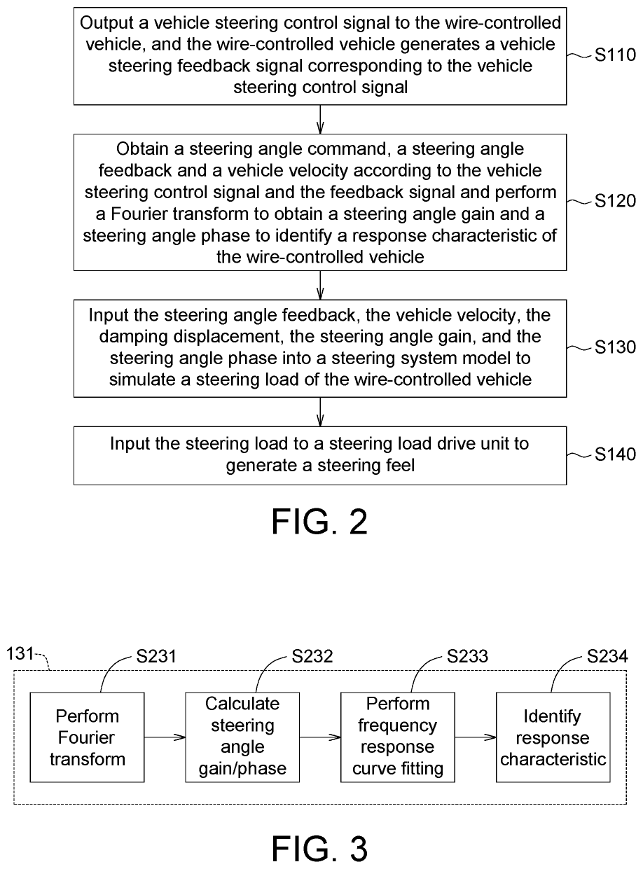

Refer to FIG. 1 and FIG. 2. FIG. 1 is a schematic diagram of a steering control device 100 and a steer-by-wire system 10 using the same according to an embodiment of the present disclosure. FIG. 2 is a schematic diagram of a steering control method according to an embodiment of the present disclosure.

According to an embodiment of the present disclosure, the steering control device 100 can be wirelessly or wiredly connected to a wire-controlled vehicle 101 to receive a steering command from an operator 102 and further transmit the steering feedback of the wire-controlled vehicle 101 to the operator 102, such that the operator 102 can have a lifelike feel of driving the wire-controlled vehicle 101. The wireless or wired connection of the vehicle is based on a controller area network (CAN) 113 and allows mutual communication between the wire-controlled vehicle 101 and the steering control device 100 without using a host.

Refer to FIG. 1. The steering control device 100 can connect the electronic device inside the wire-controlled vehicle 101 through the CAN communication protocol. For example, the mechanisms and parts (such as mechanic valve or hydraulic device) of the wire-controlled vehicle 101, which are originally operated independently, can be replaced or integrated by electronic signals which control the engine or the mechanism, and are controlled by an engine control unit (ECU), such that the manipulability and safety of the wire-controlled vehicle 101 can be greatly enhanced, and the mechanical structure and parts of the wire-controlled vehicle 101 can be simplified. Common control-by-wire applications include a steer-by-wire control, a suspension-by-wire control, a brake-by-wire control, a throttle-by-wire control and a shift-by-wire control.

Refer to FIG. 1. The steering control device 100 includes a steering control interface 110 (including a steering wheel assembly 111), a steering load drive unit 120 (including a driver unit 121 and a resistance unit 122) and a processor 130 (such as an engine control unit (ECU)). The steering control interface 110 can be connected to the wire-controlled vehicle 101 through a network (such as a CAN communication network 113) to output a vehicle steering control signal 112 (such as a steering wheel steering command and a vehicle velocity) to the wire-controlled vehicle 101. The response discrimination unit 131 can receive a vehicle steering feedback signal 104 (such as a wheel steering angle feedback 106, a vehicle velocity 108, and a road wheel steering damping displacement 109) from the wire-controlled vehicle 101. The steering load simulation unit 132 correspondingly receives a response characteristic 136 from the response discrimination unit 131 and a vehicle steering feedback signal 104 (such as a wheel steering angle feedback 106, a vehicle velocity 108, and a road wheel steering damping displacement 109) from the wire-controlled vehicle 101. The steering load drive unit 120 converts the steering load 123 of the steering load simulation unit 132 into a steering feel 124 matching real vehicle state and driving feel and then transmits the steering feel 124 to the operator 102. As indicated in step S110 of FIG. 2, a vehicle steering control signal 112 is outputted to the wire-controlled vehicle 101, and the wire-controlled vehicle 101 generates a vehicle steering feedback signal 104 corresponding to the vehicle steering control signal 112.

In the present embodiment, the steering control device 100 can be done by a control-by-wire testing device, and the steering control interface 110 (including the steering wheel assembly 111) and the steering mechanism of the wire-controlled vehicle 101 are not connected by mechanical parts (such as a steering column) and therefore are not restricted by conventional steering mechanism, and the convenience and safety of driving can be improved. The steering control interface 110 is mainly configured to convert the steering intent of the operator 102 (detected by a steering angle sensor) into a digital signal, and further transmit the digital signal to the processor 130 (ECU) to generate a vehicle steering control signal 112. Meanwhile, the steering control interface 110 also receives a torque signal fed back by the processor 130 (ECU) to generate a steering wheel rotation torque for the operator 102 to have a road feel feedback corresponding to the steering wheel rotation torque. The steering wheel assembly 111 includes a steering wheel, a steering wheel angle sensor, a torque sensor, and a control motor (or an actuator). The steering mechanism of the wire-controlled vehicle 101 mainly receives a command from the processor 130 (ECU), and controls the wheel rotation of the wire-controlled vehicle 101 using a control motor (or actuator) to implement the steering intent of the operator 102.

Refer to FIG. 1. The processor 130 includes a response discrimination unit 131 and a steering load simulation unit 132, which can be done by software and/or hardware. The response discrimination unit 131, connected to the steering control interface 110, obtains a steering angle command 114 according to the vehicle steering control signal 112 and obtains a steering angle feedback 106 and a vehicle velocity 108 according to the vehicle steering feedback signal 104. Besides, the response discrimination unit 131 further performs a fast Fourier transform (FFT) 133 to obtain a steering angle gain 134 and a steering angle phase 135 to identify a response characteristic 136 of the wire-controlled vehicle 101. As indicated in step S120 of FIG. 2, a steering angle command 114, a steering angle feedback 106, and a vehicle velocity 108 are obtained by the response discrimination unit 131 according to the vehicle steering control signal 112 and the vehicle steering feedback signal 104, and a Fourier transform 133 is performed to obtain a steering angle gain 134 and a steering angle phase 135 to identify a response characteristic 136 of the wire-controlled vehicle 101.

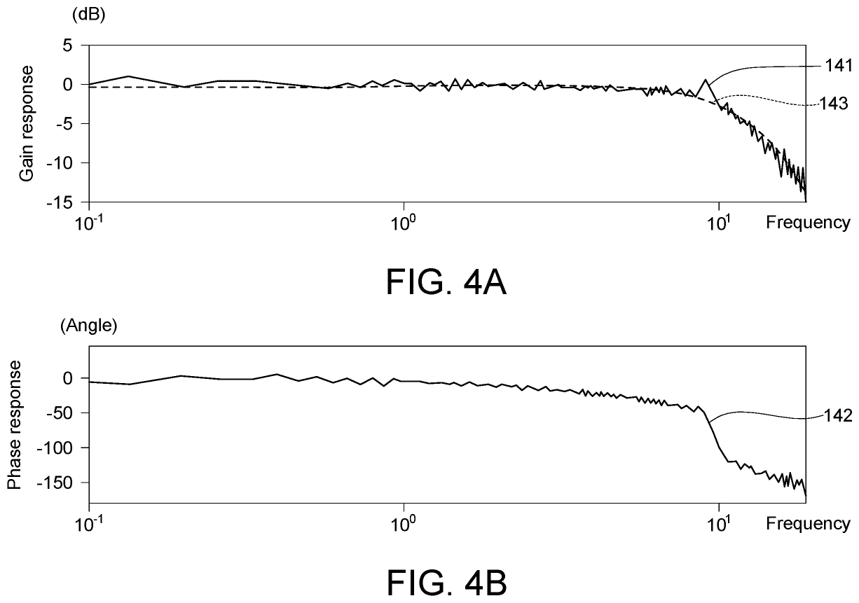

Refer to FIGS. 3, 4A and 4B. FIG. 3 is an operation diagram of a response discrimination unit 131 according to an embodiment of the present disclosure. FIGS. 4A and 4B respectively are schematic diagrams of the steering angle gain 134 and the steering angle phase 135 corresponding to the response characteristic 136 of the wire-controlled vehicle 101. In FIG. 4A, the vertical axis represents the gain response (dB), and the horizontal axis represents the frequency (Hz). In FIG. 4B, the vertical axis represents the angle (degree), and the horizontal axis represents the frequency (Hz). The response discrimination unit 131 identifies a response characteristic 136 of the wire-controlled vehicle 101 according to the steering angle gain 134 and the steering angle phase 135 to obtain a road feel feedback of the wire-controlled vehicle 101, and the operations are disclosed in steps S231 to S234. In step S231, Fourier transform 133 is performed to convert a time domain signal to a frequency domain signal, that is, time domain signals such as the steering angle command 114, the steering angle feedback 106 and the vehicle velocity 108 are converted to a spectrum formed of different frequency responses, wherein the gain represents the size of each frequency response, and the phase represents the period of each frequency response. In step S232, a steering angle gain 134 and a steering angle phase 135 can be calculated according to the spectrum converted by the Fourier transform 133 to represent a response characteristic 136 of the wire-controlled vehicle 101. In step S233, a frequency response curve fitting is performed. For example, a second-order curve is fitted using the least square method to obtain a model parameter (such as the natural frequency, the damping ratio and the mode shape) when the wire-controlled vehicle 101 steers. In step S234, a response characteristic 136 of the wire-controlled vehicle 101 is identified according to the model parameter, and the response characteristic 136 includes the steering angle gain 134, the steering angle phase 135 and the frequency response curves 141 and 142. The frequency response curves 141 and 142 of FIGS. 4A and 4B respectively are a response curve of the steering angle gain 134 relative to frequency and a response curve of the steering angle phase 135 relative to frequency. The dotted line of FIG. 4A represents the fitted curve 143.

Refer to FIG. 1. The steering load simulation unit 132 is connected to the response discrimination unit 131 and the steering load drive unit 120, wherein the steering load simulation unit 132 is configured respectively to input the steering angle feedback 106, the vehicle velocity 108, the damping displacement 109, the steering angle gain 134 and the steering angle phase 135 to a steering system model 137 to simulate a steering load 123 of the wire-controlled vehicle 101. Then, the steering load 123 is inputted to the steering load drive unit 120 for the driver unit 121 (such as motor) and the resistance unit 122 (such as pneumatic or hydraulic unit) to generate an equivalent load torque to provide real vehicle state and the steering feel 124 to the operator 102. As indicated in step S130 of FIG. 2, the steering angle feedback 106, the vehicle velocity 108, the damping displacement 109, the steering angle gain 134 and the steering angle phase 135 are inputted to a steering system model 137 to simulate a steering load 123 of the wire-controlled vehicle 101, and then the steering load 123 is transmitted to a steering load drive unit 120 to generate a steering feel 124.

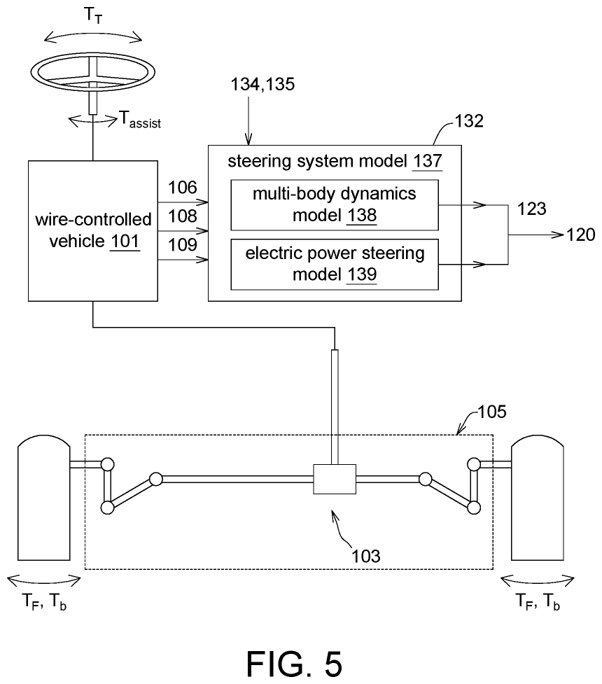

Referring to FIG. 5, a schematic diagram of a steering system model 137 according to an embodiment of the present disclosure is shown. The steering system model 137 includes a multi-body dynamics model 138 and an electric power steering model 139. The multi-body dynamics model 138 is configured to construct the model of the rigid body system of the wire-controlled vehicle 101 for the steering load simulation unit 132 to recursively calculate the resistance between the road wheel and the ground when the vehicle accelerates, reduces the velocity, steers, climbs up or drives down the slope as well as the steering torque, and further analyzes the kinetic performance of the vehicle and optimizes the parameters to obtain the operation stability and smoothness of the wire-controlled vehicle 101.

The multi-body dynamics model 138 can be expressed as:

$${J}_{f} {\ddot{δ}}_{fw} + {B}_{f} {\dot{δ}}_{fw} = {G}_{f} {T}_{f} - {F}_{r} {r}_{P} ,$$

wherein J_{f} represents the equivalent inertia of the wheel system, δ_{fw} represents the front wheel angle, B_{f} represents the coefficient of viscous friction of the wheel, G_{f} represents the gear reduction ratio, T_{f} represents the motor output torque of the front wheel, and Fᵣ represents the rack force, rₚ represents the radius of the pinion.

Moreover, the electric power steering model 139 is configured to construct assistant steering of the wire-controlled vehicle 101 for the steering load simulation unit 132 to simulate the motor (or the driver unit) to provide an assistant torque to the power steering system 105 (including the steering mechanism 103 and the connecting rod thereof) of the wire-controlled vehicle 101, such that the processor 130 can control the rotation direction and the assistant power of the motor according to the signals of the vehicle velocity sensor and the torque sensor to control the assistant torque in real-time. The motor can provide different assistant powers according to the change in the vehicle velocity to assure that the wire-controlled vehicle 101 is swift at low velocity and is stable and reliable at high velocity.

The calculation of the electric power steering model 139 is as follows:

$${J}_{c} {\ddot{δ}}_{sw} + {B}_{c} {\dot{δ}}_{sw} = {T}_{SW} - {G}_{m} {T}_{m} ,$$

wherein J_{c} represents the equivalent inertia of the steering wheel, δ_{sw} represents the steering wheel angle, B_{c} represents the coefficient of viscous friction of the steering wheel system, T_{SW} represents the operator's input torque, Gₘ represents the gear reduction ratio, and Tₘ represents the motor output torque.

Refer to FIG. 5. Generally speaking, the torque measured by the torque sensor is the manipulation torque T_{T} outputted by the wire-controlled vehicle 101, the motor output torque is the assistant torque Tₐₛₛᵢₛₜ. The steering resistance torque T_{F} includes the inertia torque, the damping torque and the friction torque of the steering mechanism 103. The manipulation torque T_{T} of the wire-controlled vehicle 101 and the assistant torque Tₐₛₛᵢₛₜ generated by the motor are configured to overcome the steering load 123 (including the steering resistance torque T_{F} composed of the aligning torque T_{b} of the road wheel and the inertia torque, the damping torque, and the friction torque of the steering mechanism 103), wherein T_{T}=T_{b}+T_{F}-Tₐₛₛᵢₛₜ. In the present embodiment, to simulate the aligning torque T_{b} of the road wheel, the steering angle feedback 106, the steering angle gain 134 and the steering angle phase 135 of the road wheel are configured as input parameters inputted to the steering system model 137 to generate a simulated aligning torque T_{b} of the road wheel, wherein T_{b}=KᵣXᵣ, Kᵣ represents the coefficient of elasticity, Xᵣ represents the angular displacement of the road wheel.

Furthermore, in the present embodiment, the vehicle steering feedback signal 104 (including the steering angle feedback 106, the vehicle velocity 108, the damping displacement 109, the steering angle gain 134 and the steering angle phase 135) is inputted to the steering system model 137 to simulate the aligning torque T_{b}, the steering resistance torque T_{F} and the assistant torque Tₐₛₛᵢₛₜ of the road wheel on real road surface to obtain the steering load 123 similar to the manipulation torque T_{T} of the wire-controlled vehicle 101.

Refer to FIG. 1. Through the simulation of the steering system model 137, the steering load 123 similar to the manipulation torque T_{T} of the wire-controlled vehicle 101 is inputted to the steering load drive unit 120 (including the driver 121 and the resistance unit 122) to generate an equivalent load torque DT_{T} to provide real vehicle state and the steering feel 124 to the operator 102, wherein DT_{T} is equivalent to T_{T}.

According to the steering control device and method for a wire-controlled vehicle disclosed in above embodiments of the present disclosure, the steering system model simulates the steering load (including the aligning torque of the road wheel and the steering resistance torque composed of an inertia torque, a damping torque and a friction torque of the steering mechanism 103) similar to the manipulation torque T_{T} of the wire-controlled vehicle 101 on real road, and transmits the steering load of the wire-controlled vehicle to a remote steering control device to generate an equivalent load torque to provide the operator with real driving feel. When a testing vehicle malfunctions or gradually loses control during the vehicle test, correct road feel feedback will be unavailable. The present disclosure resolves the unavailability problem of correct road feel feedback and increases the manipulability of the steer-by-wire system of the vehicle.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A steering control device wirelessly or wiredly connected to a wire-controlled vehicle, wherein the steering control device comprises:
a steering control interface configured to output a vehicle steering control signal to the wire-controlled vehicle, and the wire-controlled vehicle generates a vehicle steering feedback signal corresponding to the vehicle steering control signal;
a steering load drive unit configured to feedback a steering feel to an operator; and
a processor, comprising a response discrimination unit and a steering load simulation unit,
wherein, the response discrimination unit obtains a steering angle command, a steering angle feedback, and a vehicle velocity according to the vehicle steering control signal and the feedback signal, and performs a Fourier transform to obtain a steering angle gain and a steering angle phase to identify a response characteristic of the wire-controlled vehicle;
wherein, the steering load simulation unit is connected to the response discrimination unit and the steering load drive unit respectively, and the steering angle feedback, the vehicle velocity, the steering angle gain, and the steering angle phase are inputted into a steering system model to simulate a steering load of the wire-controlled vehicle, and the steering load is inputted to the steering load drive unit to generate the steering feel.

2. The steering control device according to claim 1, wherein the steering control interface comprises a steering wheel assembly, and the processor comprises an engine control unit (ECU).

3. The steering control device according to claim 1, wherein the response discrimination unit performs a frequency response curve fitting to obtain a model parameter of the wire-controlled vehicle after performing the Fourier transform.

4. The steering control device according to claim 1, wherein the steering system model comprises a multi-body dynamics model and an electric power steering model; the multi-body dynamics model is configured to construct a rigid body system of the wire-controlled vehicle to calculate an aligning torque T_{b} of road wheel of the wire-controlled vehicle and a steering resistance torque T_{F} composed of an inertia torque, a damping torque and a friction torque of the steering mechanism; the electric power steering model is configured to simulate a motor to provide an assistant torque Tₐₛₛᵢₛₜ to the steering mechanism of the wire-controlled vehicle.

5. The steering control device according to claim 4, wherein the steering load comprises the aligning torque T_{b} of the road wheel and the steering resistance torque T_{F} of the steering mechanism.

6. The steering control device according to claim 5, wherein the steering load drive unit comprises a driver and a resistance unit, and the steering load drive unit is configured to generate an equivalent load torque, which is equivalent to a manipulation torque T_{T} of the wire-controlled vehicle, wherein T_{T}=T_{b}+T_{F}−Tₐₛₛᵢₛₜ.

7. A steering control method for a wire-controlled vehicle, comprising:
outputting a vehicle steering control signal to the wire-controlled vehicle, wherein the wire-controlled vehicle generates a vehicle steering feedback signal corresponding to the vehicle steering control signal;
obtaining a steering angle command, a steering angle feedback and a vehicle velocity according to the vehicle steering control signal and the vehicle steering feedback signal;
performing a Fourier transform to obtain a steering angle gain and a steering angle phase to identify a response characteristic of the wire-controlled vehicle;
inputting the steering angle feedback, the vehicle velocity, the steering angle gain, and the steering angle phase into a steering system model to simulate a steering load of the wire-controlled vehicle; and
inputting the steering load to a steering load drive unit to generate a steering feel.

8. The steering control method according to claim 7, wherein after the Fourier transform is performed, a frequency response curve fitting is performed to obtain a model parameter of the wire-controlled vehicle.

9. The steering control method according to claim 7, wherein the steering system model comprises a multi-body dynamics model and an electric power steering model; the multi-body dynamics model is configured to construct a rigid body system of the wire-controlled vehicle to calculate an aligning torque T_{b} of the road wheel of the wire-controlled vehicle and a steering resistance torque T_{F} composed of an inertia torque, a damping torque and a friction torque of the steering mechanism; the electric power steering model is configured to simulate a motor to provide an assistant torque Tₐₛₛᵢₛₜ to the steering mechanism of the wire-controlled vehicle.

10. The steering control method according to claim 9, wherein the steering load comprises the aligning torque T_{b} of the road wheel and the steering resistance torque T_{F} of the steering mechanism.

11. The steering control method according to claim 10, wherein the steering load drive unit comprises a driver and a resistance unit configured to generate an equivalent load torque, which is equivalent to a manipulation torque T_{T} of the wire-controlled vehicle, T_{T}=T_{b}+T_{F}−Tₐₛₛᵢₛₜ.
